(19) United States
(12) Patent Application Publication
(10) Pub. No.: US 2018/0297703 A1
(43) Pub. Date: Oct. 18, 2018

(54) Unmanned aerial vehicle which fetches objects automatically and method thereof

(71) Applicant: Haoxiang Electric Energy (Kunshan) Co., Ltd., Kunshan (CN)

(72) Inventors: Yu Tian, Kunshan (CN); Wenyan Jiang, Kunshan (CN)

(73) Assignee: Haoxiang Electric Energy (Kunshan) Co., Ltd.

(21) Appl. No.: 16/013,170

(22) Filed: Jun. 20, 2018

(30) Foreign Application Priority Data
Jun. 21, 2017 (CN) 201710474623.6

(51) Int. Cl. B64C 39/02; B64D 1/00; G05D 1/10; G05D 1/00; B25J 15/00; G06Q 30/06

(52) U.S. Cl. CPC B64C 39/024; B64D 1/00; G05D 1/101; G05D 1/0088; B64C 2201/141; G06Q 30/0601; B64C 2201/024; B64C 2201/128; B25J 15/0028

(57) ABSTRACT

An unmanned aerial vehicle which fetches objects automatically and a method thereof is disclosed. The unmanned aerial vehicle is adopted to fetch objects at different altitudes. The method of fetching objects by the unmanned aerial vehicle comprises the following steps: capturing position information and identity information of the objects; determining a destination and planning a flight route; flying the unmanned aerial vehicle to the destination along the flight route; identifying and collecting a pre-set identity information on surfaces of the objects at the destination; matching the pre-set identity information with a captured identity information; targeting an object the pre-set identity information of which coincides with the captured identity; and controlling a mechanical paw settled on the unmanned aerial vehicle; capturing the object; delivering the object to a pre-set position. The present invention is able to replace human and walking robot.

### CROSS REFERENCE OF RELATED APPLICATION

This application claims priority under 35 U.S.C. 119(a-d) to CN 201710474623.6, filed Jun. 21, 2017.

### BACKGROUND OF THE PRESENT INVENTION

### Field of Invention

The present invention relates to an unmanned aerial vehicle, and more particularly to an unmanned aerial vehicle which is able to fetch objects automatically to and a method thereof.

### Description of Related Arts

A shopping guide robot is able to lead customers to where the commodities are and help the customers to deliver the commodities. The commodities are not able to be reached when the commodities are placed in high places.

### SUMMARY OF THE PRESENT INVENTION

The present invention provides a method for fetching objects by an unmanned aerial vehicle. The method comprises the following steps: capturing position information and identity information of the objects; determining a destination and planning a flight route according to the position information of the objects; flying the unmanned aerial vehicle to the destination along the flight route; identifying and collecting a pre-set identity information on surfaces of the objects at the destination; matching the pre-set identity information with a captured identity information; targeting an object the pre-set identity information of which coincides with the captured identity; and controlling a mechanical paw settled on the unmanned aerial vehicle; capturing the object; delivering the object to a pre-set position.

One possible way to realize the present invention comprises step of capturing position information and identity information of the objects, which further comprises steps of capturing the position information and the identity information of the objects prestored in the unmanned aerial vehicle, or, receiving the position information and the identity information of the objects from outside.

In a second possible way to realize the present invention, the pre-set identity information is the graphic information.

In a third possible way to realize the present invention, the graphic information is a bar code and/or a QR (Quick Response) code.

In a fourth possible way to realize the present invention, the position information comprises coordinates of the objects in a pre-defined coordinate reference system.

The present invention provides the unmanned aerial vehicle which comprises a body of the unmanned aerial vehicle on which there is a mechanical paw, an information acquiring unit for acquiring position information and identity information of the objects, an identification and acquisition unit for identifying and collecting pre-set identity information on surfaces of the objects in an acquired position, and a control unit; wherein the control unit determines a destination and plans a flight route and fly the unmanned aerial vehicle to the destination along the flight route; the control unit matches the pre-set identity information with a captured identity information and targets an object the pre-set identity information of which coincides with the captured identity; the control unit controls a mechanical paw settled on the unmanned aerial vehicle to capture the object and delivers the object to a pre-set position.

In a possible way to realize the present invention, the information acquiring unit is for acquiring the position information and the identity information of the objects from information prestored in the unmanned aerial vehicle and receiving the position information and the identity information of the objects from outside.

In a second possible way to realize the present invention, the pre-set identity information is the graphic information.

In a third possible way to realize the present invention, the graphic information is the bar code and/or the QR code.

In a fourth possible way to realize the present invention, the position information comprises coordinates of the objects in a pre-defined coordinate reference system.

The present invention provides an unmanned aerial vehicle which is able to fetch the objects and the method thereof. The unmanned aerial vehicle is able to acquire the position of the objects, calculate the flight route according to a relative position of the objects and the unmanned aerial vehicle and fetch the objects. The present invention provides an unmanned aerial vehicle which is able to fetch the objects and the method thereof, which is able to replace the human and the walking robot.

### BRIEF DESCRIPTION OF THE DRAWINGS

In order to better illustrate the technical solution disclosed in the embodiments, a brief introduction on the drawings are listed below. Obviously, the drawings illustrate the embodiments of the present invention. A skilled worker in this field is able to achieve other drawings based on the drawings without creation and innovation.

FIG. 1 is a perspective view of an unmanned aerial vehicle for fetching objects in one of the embodiments;

FIG. 2 is a perspective view of a structure of the unmanned aerial vehicle in one of the embodiments;

FIG. 3 is a perspective view of an application of the unmanned aerial vehicle in one of the embodiments.

### DETAILED DESCRIPTION OF THE PREFERRED EMBODIMENT

Referring to the drawings, the object, technical solution and advantages of the embodiments of the present invention are clearly and fully illustrated. Obviously, the embodiments listed below are part of the embodiments. A skilled worker in the field is able to achieve other embodiments based on the embodiments of the present invention without creation and innovation. All the embodiments are within the protection scope of the present invention.

A lot of details are described for a better understanding of the present invention, part of which are not a must for practicing the present invention.

The embodiments and the features in the embodiments are able to be re-combined. Referring to the drawings, detailed descriptions of the present invention are listed below.

In the super market and the shopping mall, most of the commodities are placed on the shelves. Each commodity is in a fixed position. Set a corner of the wall or a cash register as the origin of the coordinate. Each commodity in the coordinate system uniquely corresponds to a coordinate. After the unmanned aerial vehicle acquires the position information (coordinate) and the identity information of the objects, the direction relation between the unmanned aerial vehicle and the objects are calculated and the flight route to the objects are further calculated (which is the destination, such as 20 cm in front of the objects or 20 cm above the objects). The unmanned aerial vehicle flies to the destination along the flight route. The unmanned aerial vehicle determines the objects after reaches the destination, which comprises the following steps collecting the graphic/image information of the objects on the shelves, matching and comparing the collected information with the acquired identity information of the object and determining the object which coincides with identity information to be the object needs fetching. The object is fetched by the unmanned aerial vehicle and delivered to a preset position in the cash register.

The present invention is described in detail as below.

FIG. 1 is a perspective view of an unmanned aerial vehicle for fetching objects. The method of fetching object by the unmanned aerial vehicle comprises the following steps.

S110: capturing position information and identity information of the objects.

The position information of the objects comprises an altitude relative to the ground, a distance to a first reference plane and a distance to a second reference plane; wherein the ground, the first reference plane and the second reference plane are vertical to each other and are the three datums of a spatial coordinate system. The position coordinate of the object in the spatial coordinate system is the position information. The first reference plane and the second reference plane are able to be two walls which meet at right angles.

The identity information of the objects comprises a product name, a manufacture, specifications, a price and a production date. The identity information is able to be acquired from outside or the prestored identity information of various commodities in the unmanned aerial vehicle. The identity information of the objects is able to be retrieved from the prestored identity information. Specifically, intelligent terminals are able to be placed in the super market/shopping mall. The customers are able to choose the commodities on the intelligent terminals. The intelligent terminals send the identity information of the commodities to the unmanned aerial vehicle. The unmanned aerial vehicle receives the identity information and acquires the identity information of the objects. Or, the identity information and the position information of various commodities are prestored in the unmanned aerial vehicle. The intelligent terminals send the identity information and the position information of commodities chosen by the customers to the unmanned aerial vehicle and retrieve the identity information and the position information of the objects from the unmanned aerial vehicle.

S120: determining a destination and planning a flight route according to the position information of the objects; flying the unmanned aerial vehicle to the destination along the flight route.

After the position of the objects is determined, the direction of the objects relative to the unmanned aerial vehicle is able to be calculated by comparing the position of the unmanned aerial vehicle with the position of the objects. The nearest/wisest route approaching the objects (the destination) is further calculated. For example, the space containing the objects is defined as a space containing three coordinates x, y and z which are orthogonal to each other. The coordinates of the object is (1000, 5000, 4000). The position of the unmanned aerial vehicle is set as the origin of the coordinate. The unmanned aerial vehicle acquires the position information of the object and calculates the safest route, which is flying to (2000, 0, 0), moving horizontally to (2000, 5000, 4200) and landing on (1000, 5000, 4200). The unmanned aerial vehicle lands 200 mm in front of the object. The unmanned aerial vehicle hovers on the position before the next operation.

The destination is the preset position near the objects. The fetching method may different according to the different positions of the objects on the shelves. The unmanned aerial vehicle may need to move horizontally along the positive direction of axis y, along the negative direction of axis z, or along the positive direction of axis x (upward). The corresponding destination is set according to the specific situation of the objects for the next operation.

In optional embodiments, the unmanned aerial vehicle is able to judge whether there are human activities near the objects by infrared sensors or face recognition to prevent the unmanned aerial vehicle from hitting the person. Specifically, the unmanned aerial vehicle is able to collect the image information of the destination in advance at (2000, 5000, 4200) by cameras and determines whether there is people. If there are human activities at the destination, the unmanned aerial vehicle waits until the people leave or sends warning by voice/flash. The unmanned aerial vehicle judges whether there are human activities at the destination by infrared sensors or determines the distance between the people and the destination. If the people keep a safe distance from the destination, the unmanned aerial vehicle continues the fetching.

S130: identifying and collecting pre-set identity information on surfaces of the objects at the destination; matching the pre-set identity information with captured identity information; targeting an object the pre-set identity information of which coincides with the captured identity.

When reaches the destination, the unmanned aerial vehicle collects images of the objects in front of the camera. The inherent shape, pattern, color of the objects and the identity information such as the bar code/QR (Quick Response) code printed or stuck to the objects are collected by the camera. The collected information is compared and matched with the identity information captured in the step S110 to determine whether the object scanned by the camera is the object needs fetching. The object is determined to be the object needs fetching if the collected information coincides with the identity information.

If the collected information does not coincide with the identity information, the unmanned aerial vehicle positions itself and measures the distance between the unmanned aerial vehicle and the reference coordinate to determine whether the unmanned aerial vehicle is at the destination. If the result is not at the destination, the unmanned aerial vehicle adjusts the position of itself until reaches the destination before re-identifying and re-collecting the identity information pre-set on the surface of the object at the destination.

S140: controlling a mechanical paw settled on the unmanned aerial vehicle; capturing the object; delivering the object to a pre-set position.

There is a mechanical paw set on the unmanned aerial vehicle for fetching the objects. When the destination is determined, the unmanned aerial vehicle flies to or moves the mechanical paw to the destination to fetch the objects. The openness of the mechanical paw is adjustable according to the size of the objects. The pressure sensors may be set on the mechanical paw to determine whether the objects are held by the mechanical paw.

The unmanned aerial vehicle returns along the original flight route after the objects are fetched. The objects are delivered to the origin of coordinate. The objects are also able to be delivered to a specified position. For example, when a customer operates on a certain intelligent terminal, the most convenient position for delivering the objects is the intelligent terminal. The unmanned aerial vehicle is able to calculate the route between the unmanned aerial vehicle and the intelligent terminal, fly to the intelligent terminal along the route and deliver the objects to the customer.

The present invention provides a method for fetching the objects by the unmanned aerial vehicle, which is able to replace human or the walking robot and bring significant convenience to customers.

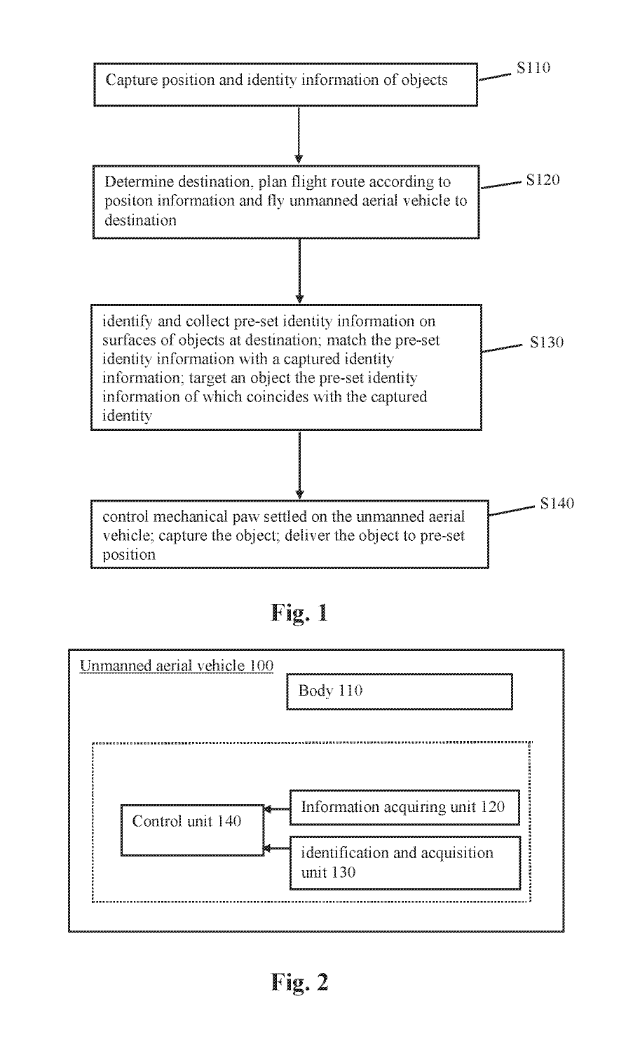

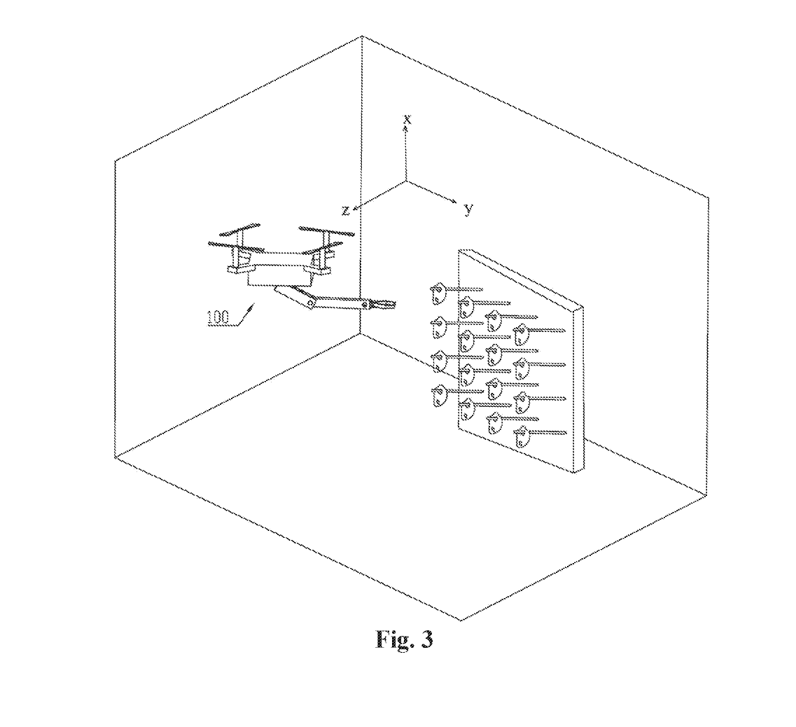

FIG. 2 is a prospective view of the structure of the unmanned aerial vehicle 100 in one of the embodiments of the present invention. FIG. 3 is a perspective view of an application of the unmanned aerial vehicle in one of the embodiments of the present invention.

The unmanned aerial vehicle 100 comprises a body 110, an information acquiring unit 120, an identification and an acquisition unit 130 and a control unit 140. The body 110 is the carrier for various software and hardware and for the various units to install on. There is a mechanical paw set on the unmanned aerial vehicle 110. The information acquiring unit 120 acquires the position information and identity information of the objects. The identification and acquisition unit 130 identifies and collects the identity information pre-set on the surface of the objects at the destination. The control unit 140 determines the destination, plans the flight route according to the position information of the objects and flies the unmanned aerial vehicle 100 to the destination. The control unit 140 matches the pre-set identity information with the captured identity information of the objects and determines the object coincides with captured identity information to be the object needs fetching. The control unit 140 also controls the mechanical paw on the unmanned aerial vehicle 100 to fetch the objects and deliver the objects to a specified position.

Specifically, the position information of the objects comprises an altitude relative to the ground, a distance to a first reference plane and a distance to a second reference plane; wherein the ground, the first reference plane and the second reference plane are vertical to each other and are the three datums of a spatial coordinate system. The position coordinate of the object in the spatial coordinate system is the position information. The first reference plane and the second reference plane are able to be two walls which meet at right angles.

The identity information of the objects comprises a product name, a manufacture, specifications, a price and a production date. The identity information is able to be acquired from outside or the prestored identity information of various commodities in the unmanned aerial vehicle 100. The identity information of the objects is able to be retrieved from the prestored identity information. Specifically, intelligent terminals are able to be placed in the super market/shopping mall. The customers are able to choose the commodities on the intelligent terminals. The intelligent terminals send the identity information of the commodities or the corresponding code of the identity information to the unmanned aerial vehicle 100. The unmanned aerial vehicle 100 receives the identity information and acquires the identity information of the objects.

The control unit 140 of the unmanned aerial vehicle 100 is able to determine the destination, plan the flight route according to the position information of the objects and fly the unmanned aerial vehicle 100 along the flight route to the destination. The flight route is able to be calculated on other devices besides the unmanned aerial vehicle 100 and sent back to the unmanned aerial vehicle 100.

After the position of the objects is determined, the direction of the objects relative to the unmanned aerial vehicle 100 is able to be calculated by comparing the position of the unmanned aerial vehicle with the position of the objects. The nearest/wisest route approaching the objects is further calculated. For example, the space containing the objects is defined as a space containing three coordinates x, y and z which are orthogonal to each other. The coordinates of the object is (1000, 5000, 4000). The position of the unmanned aerial vehicle 100 is set as the origin of the coordinate. The unmanned aerial vehicle 100 acquires to the position information of the object and the control unit 140 calculates the safest route, which is flying to (2000, 0, 0), moving horizontally to (2000, 5000, 4200) and landing on (1000, 5000, 4200). The unmanned aerial vehicle 100 lands 200 mm in front of the object. The unmanned aerial vehicle 100 hovers on the position before the next operation.

The destination is the preset position near the objects. The fetching method may different according to the different positions of the objects on the shelves. The unmanned aerial vehicle 100 may need to move horizontally along the positive direction of axis y, along the negative direction of axis z, or along the positive direction of axis x (upward). The corresponding destination is set according to the specific situation of the objects for the next operation.

In optional embodiments, the unmanned aerial vehicle 100 is able to judge whether there are human activities near the objects by infrared sensors or face recognition to prevent the unmanned aerial vehicle 100 from hitting the person. Specifically, the unmanned aerial vehicle 100 is able to collect the image information of the destination in advance at (2000, 5000, 4200) by cameras and determines whether there is people. If there are human activities at the destination, the unmanned aerial vehicle 100 waits until the people leave or sends warning by voice/flash. The unmanned aerial vehicle 100 judges whether there are human activities at the destination by infrared sensors or determines the distance between the people and the destination. If the people keep a safe distance from the destination, the unmanned aerial vehicle continues the fetching.

The identification and acquisition unit 130 identifies and collects pre-set identity information on surfaces of the objects at the destination and sends the collected information to the control unit 140. The control unit 140 matches the pre-set identity information with captured identity information and targets an object the pre-set identity information of which coincides with the captured identity. Specifically, when reaches the destination, the unmanned aerial vehicle 100 collects images of the objects in front of the camera. The inherent shape, pattern, color of the objects and the identity information such as the bar code/QR code printed or stuck to the objects are collected by the camera. The collected information is compared and matched with the captured identity information to determine whether the object scanned by the camera is the object needs fetching. The object is determined to be the object needs fetching if the collected information coincides with the identity information.

If the collected information does not coincide with the identity information, the unmanned aerial vehicle 100 positions itself and measures the distance between the unmanned aerial vehicle and the reference coordinate to determine whether the unmanned aerial vehicle is at the destination. If the result is not at the destination, the unmanned aerial vehicle adjusts the position of itself until reaches the destination before re-identifying and re-collecting the identity information pre-set on the surface of the object at the destination.

The control unit 140 controls a mechanical paw settled on the unmanned aerial vehicle 100 to fetch the objects and delivers the object to a pre-set position.

There is a mechanical paw set on the unmanned aerial vehicle 100 for fetching the objects. After the control unit 140 determines the objects, the unmanned aerial vehicle 100 flies to or moves the mechanical paw to the destination to fetch the objects. The openness of the mechanical paw is adjustable according to the size of the objects. The pressure sensors may be set on the mechanical paw to determine whether the objects are held by the mechanical paw.

The unmanned aerial vehicle 100 returns along the original flight route after the objects are fetched. The objects are delivered to the origin of coordinate. The objects are also able to be delivered to a specified position. For example, when a customer operates on a certain intelligent terminal, the control unit 140 controls the unmanned aerial vehicle 100 to deliver the objects to the intelligent terminal for the convenience of the customer.

The control unit 140 of the unmanned aerial vehicle 100 is able to calculate the route between the unmanned aerial vehicle and the intelligent terminal and control the unmanned aerial vehicle 100 to fly to the intelligent terminal along the route and deliver the objects to the customer.

The embodiments are just for illustration of the present invention but not a limitation of the present invention. A skilled worker in the field is able to easily modify and replace the contents which are within the protection scope of the present invention. The protection scope of the present invention is based on the claims.

What is claimed is:

1. A method of fetching objects by an unmanned aerial vehicle, comprising following steps of:
capturing position information and identity information of the objects;
determining a destination and planning a flight route according to the position information of the objects; flying the unmanned aerial vehicle to the destination along the flight route;
identifying and collecting pre-set identity information on surfaces of the objects at the destination; matching the pre-set identity information with a captured identity information; targeting an object the pre-set identity information of which coincides with the captured identity; and
controlling a mechanical paw settled on the unmanned aerial vehicle; capturing the object; delivering the object to a pre-set position.

2. The method of fetching the objects by the unmanned aerial vehicle, as recited in claim 1, wherein capturing position information and identity information comprises a step of:
capturing the position information and the identity information of the objects prestored in the unmanned aerial vehicle,
or,
receiving the position information and the identity information of the objects from outside.

3. The method of fetching the objects by the unmanned aerial vehicle, as recited in claim 1, wherein the pre-set identity information is graphic information.

4. The method of fetching the objects by the unmanned aerial vehicle, as recited in claim 3, wherein the graphic information is a bar code and/or a QR (Quick Response) code.

5. The method of fetching the objects by the unmanned aerial vehicle, as recited in claim 1, wherein the position information comprises coordinates of the objects in a pre-defined coordinate reference system.

6. An unmanned aerial vehicle which fetches objects automatically, comprising a body of the unmanned aerial vehicle on which there is a mechanical paw, an information acquiring unit for acquiring position information and identity information, an identification and acquisition unit for identifying and collecting pre-set identity information on surfaces of the objects in an acquired position, and a control unit; wherein the control unit determines a destination and plans a flight route and flies the unmanned aerial vehicle to the destination along the flight route; the control unit matches the pre-set identity information with a captured identity information and targets an object the pre-set identity information of which coincides with the captured identity; the control unit controls the mechanical paw settled on the unmanned aerial vehicle to capture the object and delivers the object to a pre-set position.

7. The unmanned aerial vehicle which fetches the objects automatically, as recited in claim 6, wherein the information acquiring unit is for acquiring the position information and the identity information of the objects from information prestored in the unmanned aerial vehicle and receiving the position information and the identity information of the objects from outside.

8. The unmanned aerial vehicle which fetches the objects automatically, as recited in claim 6, wherein the pre-set identity information is graphic information.

9. The unmanned aerial vehicle which fetches the objects automatically, as recited in claim 8, wherein the graphic information is a bar code and/or a QR code.

10. The unmanned aerial vehicle which fetches the objects automatically, as recited in claim 6, wherein the position information comprises coordinates of the objects in a pre-defined coordinate reference system.
